(19) United States
(12) Patent Application Publication
(10) Pub. No.: US 2006/0083875 A1
(43) Pub. Date: Apr. 20, 2006

(54) Lap sealable laminate for retort pouch

(75) Inventor: Rodney M. Weaver, Florence, SC (US)

Correspondence Address: IP GROUP OF DLA PIPER RUDNICK GRAY CARY US LLP, 1650 MARKET ST, SUITE 4900, PHILADELPHIA, PA, 19103, US

(73) Assignee: Sonoco Development, Inc., a corporation of South Carolina, Hartsville, SC (US)

(21) Appl. No.: 11/252,150

(22) Filed: Oct. 17, 2005

Related U.S. Application Data
(60) Provisional application No. 60/619,348, filed on Oct. 15, 2004.

(51) Int. Cl. B32B 27/32

(52) U.S. Cl. 428/35.2; 428/35.7

(57) ABSTRACT

Lap sealable laminates and pouches made therefrom that can withstand retort conditions, periods of storage and subsequent rethermalization are described. The laminate includes a core formed from at least one plastic strength layer of, for example, polyester, nylon, cast polypropylene or oriented polypropylene, and a barrier layer formed from ethylene vinyl alcohol copolymer, Nylon-MXD6, polyvinylidene chloride, an inorganic oxide coating or an organic coating. The core includes first and second major surfaces. A heat seal layer of, for example, polypropylene or cross-linked polyethylene is laminated to each of the major surfaces with a high temperature laminating adhesive. A retortable pouch with a longitudinal lap seal can be formed from the laminate on a form-fill-seal machine.

### CROSS-REFERENCE TO RELATED APPLICATION

This application claims the benefit of U.S. Provisional Application No. 60/619,348, filed Oct. 15, 2004. This earlier provisional application is herby incorporated by reference.

### FIELD OF THE INVENTION

The invention relates to the field of consumables packaging, and particularly to retort pouches and materials for forming them.

### BACKGROUND OF THE INVENTION

It has become common to package consumables in pouches. Examples of such pouches include pillow pouches, gusseted pouches, and various forms of side-seal pouches. A special type of pouch is the retortable or “retort pouch”. A retort pouch can be filled with consumables and sealed. The consumables can then be sterilized within the pouch by subjecting the pouch to high temperature, usually at or above 120 degrees C., for a pre-selected period of time. Retort sterilization can be performed using commercially available equipment, often involving a pressure vessel into which steam is introduced under regulated pressure.

Special considerations must be made when selecting a packaging material to be used for retort applications. Typically, the material must have barrier properties against the transmission of moisture, oxygen and/or carbon dioxide. Such barrier properties are desired to keep the product fresh until the pouch is opened and the contents consumed. Maintaining package integrity is another concern because of the heat to which the pouch is exposed and the associated high pressure that can develop within the pouch during the retort process. Consideration must also be given to the effects that retort conditions may have on chemical agents, which may be present in the packaging material as processing additives or the like. It is important that potentially harmful chemical agents not be permitted to leach into the package interior and taint the consumables. In this respect, the producer of retort materials must use compositions and film structures that meet specifications set forth in government regulations, such as those promulgated in the United States at 21 C.F.R. § 177.1390.

In order to satisfy the requirements dictated for retort applications, most conventional retort films have dissimilar outer layers. For example, a conventional retort pouch may have a heat sealable outer layer, such as polyethylene, on the inside surface, and a heat resistant outer layer, such as polyester, on the outside surface. Such dissimilar outer layers cannot normally be heat sealed to each other in a vertical form-fill-seal machine. Thus, many retort pouches must first be made in a pouch forming machine prior to the filling and sealing steps. The two step process requires expense of both time and labor in the packaging process. In addition, pouches having dissimilar outer layers must generally be sealed by longitudinal fin seals, which do not provide optimal abuse resistance.

Several of the above problems are recognized and described by Dayrit et al. in International patent application publication WO 02/074537. Specifically, Dayrit describes a coextruded multi-layer film for forming lap sealed retort pouches in a vertical form-fill-seal process. The film includes a core layer of ethylene vinyl alcohol bounded on each side by a polyamide layer (nylon), a polymeric tie layer and an outer sealant layer of polyethylene or polypropylene. The multi-layer film is a coextrusion in which the outer sealant layers are bonded to the core by the polymeric tie layers during the extrusion process.

Although the ideas described by Dayrit represent a significant advance in the art, a need continues to exist for a film structure that can withstand retort conditions, periods of storage and subsequent rethermalization.

### SUMMARY OF THE INVENTION

The present invention relates to lap sealable laminates that can withstand retort conditions, storage and subsequent rethermalization. The invention further relates to retortable pouches that can be formed from the laminates on vertical or horizontal form-fill-seal machines.

A laminate according to the present invention includes a core formed from at least one plastic strength layer of, for example, polyester, nylon, cast polypropylene or oriented polypropylene, and a barrier layer formed from ethylene vinyl alcohol copolymer, Nylon-MXD6, polyvinylidene chloride, an inorganic oxide coating or an organic coating. The core includes first and second major surfaces. A heat seal layer is laminated to each of the major surfaces with a high temperature laminating adhesive. The heat seal layers are formed from a material having a melting point above 120 degrees C.

A retortable pouch can be formed on a form-fill-seal machine. Such a pouch can be made by forming the laminate into a tubular structure, sealing, for example, a bottom seal and a longitudinal lap seal, filling the tube with a consumable material and sealing the top. The pouch can withstand retort sterilization, cooling, storage and subsequent rethermalization.

### BRIEF DESCRIPTION OF THE DRAWINGS

For the purpose of illustrating the invention, there are shown in the drawings forms which are presently preferred; it being understood, that this invention is not limited to the precise arrangements and instrumentalities shown.

FIG. 1 is a schematic cross-sectional view of a retortable laminate according to an embodiment of the invention.

FIG. 2 is a schematic representation of production apparatus for making the laminate of FIG. 1.

FIG. 3 is a schematic cross-sectional view of a retortable laminate according to another embodiment of the invention.

FIG. 4 is a schematic representation of production apparatus for making the laminate of FIG. 3.

FIG. 5 is a rear view of a lap-sealed pillow pouch according to an embodiment of the invention.

FIG. 6 is a front view of a three-side seal pouch according to an embodiment of the invention.

### DETAILED DESCRIPTION OF THE DRAWINGS

In the Figures, in which like reference numerals indicate like elements, there are shown embodiments of retortable laminates that are capable of being lap sealed by means of heat, apparatus for making the laminates and retortable pouches formed from the laminates. As used herein, the term “laminate” means a multi-layer flexible material in which at least one pre-formed layer is adhered to another pre-formed layer by an adhesive.

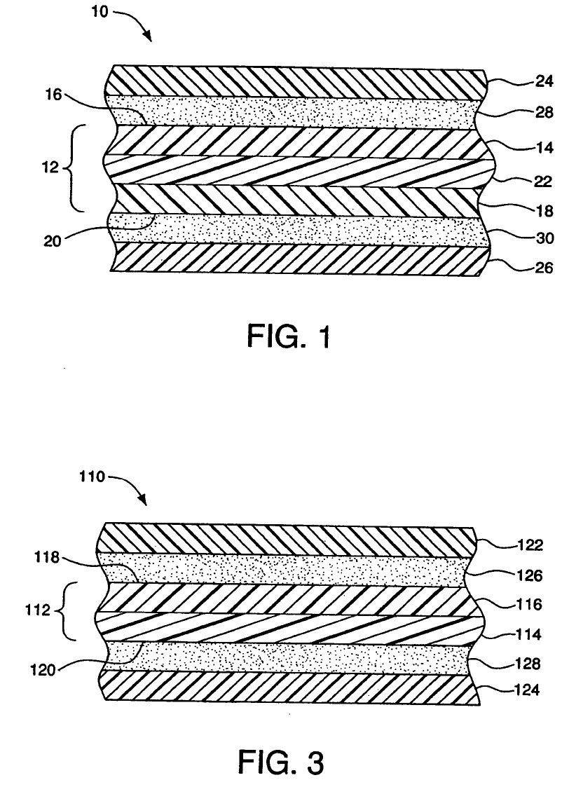

The retortable laminate 10 according to FIG. 1 includes a core 12 having a first strength layer 14. The first strength layer 14 provides the core with a first major surface 16. The core 12 includes a second strength layer 18, which provides a second major surface 20. The strength layers are formed from heat resistant plastic material having a high vicat softening point, preferably greater than 180 degrees C. Suitable materials include nylon, such as Nylon-6, polyester, oriented polypropylene (“OPP”) and cast polypropylene (“CPP”), Nylon-6 or polyester being preferred.

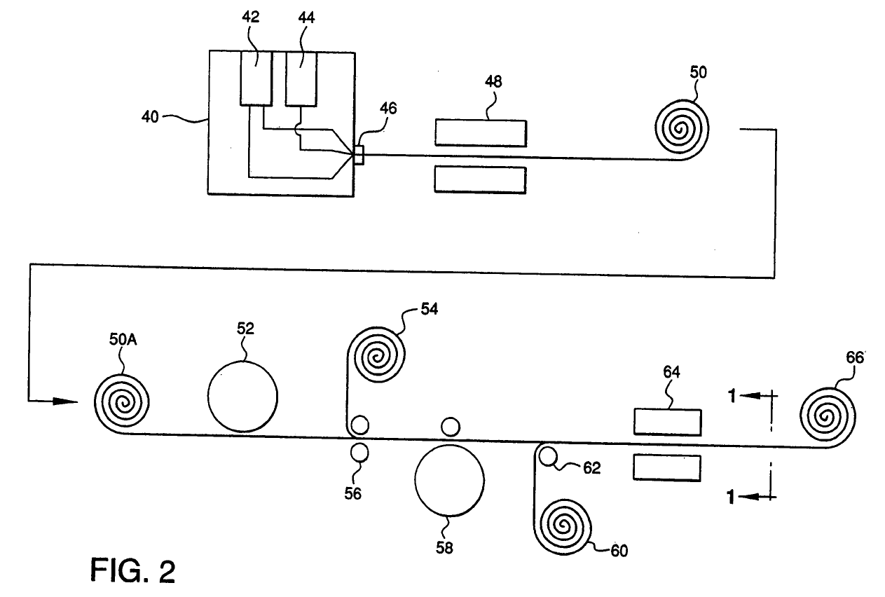

The core 12 also includes a barrier layer 22 interposed between the strength layers 14, 18. Suitable materials for forming the barrier layer 22 include ethylene vinyl alcohol copolymer (“EVOH”) and aromatic nylon, such as Nylon-MXD6 (“MXD6”). When extrudable resins, such as these materials, are used as the barrier layer, the core 12 can be formed by coextruding the strength layers 14, 18 with the barrier layer 22 through an A-B-A type feedblock. The apparatus for producing the laminate 10 will be discussed in more detail below with regard to FIG. 2.

The laminate 10 includes a heat seal layer 24, 26 bonded to each of the first and second major surfaces 16, 20. A high temperature laminating adhesive 28 is used to laminate the heat seal layer 24 to the first major surface 16; and a high temperature laminating adhesive 30 is used to bond heat seal layer 26 to the second major surface 20. As used herein, the term “high temperature laminating adhesive” means a solvent-based, water-based or 100 percent solids (solventless) aliphatic bonding agent that is applied to one or two pre-formed substrates and that, upon curing, substantially maintains adhesion (ability to bond to an adjacent material) and cohesion (ability to resist internal failure) at a temperature of at least 120 degrees C. Examples of commercially available solvent-based adhesives that can be used in the present invention include Henkel/Liofol 7909 and 2780 and Rohm & Haas 506-40 and 812. Suitable solventless adhesives include Henkel/Liofol 7991 and 7993.

The material of the heat seal layers 24, 26 is selected to form heat seals that can withstand retort sterilization, such as from 120 to 135 degrees for between ten minutes and two hours, and also subsequent rethermalization. Such materials have a melting temperature of greater than 135 degrees C. and can include cross-linked polyethylene (“XLPE”), which can have a melting temperature of from 150 to 170 degrees C., and cast polypropylene (“CPP”), which can have a typical melting temperature of about 170 degrees C. Such materials can provide a hermetic seal when a pouch is formed from the laminate on a form-fill-seal machine. Provided proper heat sealing conditions are used, the seals can withstand retort sterilization, cooling, storage and subsequent rethermalization.

The laminate 10 can be made using the method and apparatus schematically shown in FIG. 2. An extruder 40 has a first hopper 42 for receiving resin to be melted and formed into the strength layers 14, 18. The extruder 40 has a second hopper 44 for receiving a barrier resin. The resins in hoppers 42, 44 are melted and conveyed through melt pipes to an A-B-A type feed block and extruded through a T-die 46. The melt curtain from the die can be deposited onto a chill roll and oriented at an orientation station 48. Orientation can be achieved by stretching in the machine direction by a pair of rollers rotating at different speeds. The coextruded sheet can also, or alternatively, be oriented in the transverse direction by means of a tenter frame at the orientation station 48. The degrees and directions of orientation will depend on the end application and the resins used for the strength layers 14, 18 and the barrier layer 22.

It is also possible to coextrude the resins through an annular die and blow the film to stretch the coextrusion in the transverse direction. The bubble can be supported by an A-frame for cooling and then collapsed. The appropriate extrusion techniques for the desired end application can be selected by one of skill in the art based on the resins chosen for the strength and barrier layers.

After the coextruded core 12 has been sufficiently cooled, it is wound onto a take up roll 50. The extrusion process produces a sheet that can be used as the core 12 of the laminate 10 of FIG. 1. The take-up roll can become the supply roll 50A for an adhesive lamination process to laminate the heat seal layers 24, 26 onto each major surface of the core 12.

In the lamination process, the supply roll 50A is unwound and passed through an adhesive coating station 52 where a high temperature laminating adhesive is coated onto the first major side of the core 12. A film of heat sealable material is unwound from roll 54 and brought into contact with the adhesive-coated first major side. The combined core 12 and heat seal layer pass between a pair of nip rolls 56, which press the layers together. The combined film is passed through a second adhesive coating station 58, where the second major side of the core 12 is coated with high temperature laminating adhesive. The film is then combined with a heat seal film from supply roll 60, which is brought into contact with the high temperature laminating adhesive on the second major side, and then passed between a second set of nip rolls 62. After the heat seal layers have been combined with the core, the structure is passed through a curing station 64. The curing station may be a thermal drier if solvent- or water-based adhesive is used as the high temperature laminating adhesive. Depending on the properties of the adhesive selected, an intermediate drying unit can also be included along the lamination line between nip rolls 56 and the second coating station 58.

After the adhesive has been at least partially cured, the laminate 10 can be wound onto a take up roll 66. The take up roll 66 can be used on site or shipped to a packager. In either circumstance, the laminate 10 can be used in a vertical or horizontal form-fill-seal machine to produce pouches filled with consumables.

It should also be noted that the laminate 10 can be printed if desired. A printing station (not shown) can be included in the lamination process line immediately prior to or “up stream” from adhesive coating station 52 or adhesive coating station 58. Such a printing station can include one or more gravure, flexo or other known printing units, intermediate dryers and a final dryer to cure the printed ink. Multiple printing units will typically be required at the printing station if more than one color is to be printed. When printing is desired, the heat seal layer and high temperature laminating adhesive laminated onto the printed side of the core should be selected to exhibit clarity.

A second embodiment of a lap sealable retortable laminate is shown schematically in FIG. 3. The laminate 110 includes a core 112, which includes a strength layer 114 made of at least one sheet of material with a high melting point and a barrier layer 116. The strength layer 114 can be nylon, such as Nylon-6, polyester, OPP or CPP, Nylon-6 or polyester being preferred. The exposed surface of the barrier layer 116 and the uncoated surface of the strength layer 114 provides the first major surface 118 and the second major surface 120 of the core 112, respectively. If additional layers are included in the core 112, the outermost surface of one of the additional layers can provide the first or second major surface of the core 112.

The strength layer 114 is coated with a barrier coating to provide the barrier layer 116. Examples of suitable barrier coatings include polyvinylidene chloride (“PVDC”), organic coatings and inorganic oxide coatings. Inorganic oxides can include aluminum or silicon oxide, as well as those of iron, nickel, chromium, tantalum, molybdenum, magnesium, lead or mixtures thereof. Such coatings can be applied by physical coating processes, such as electron beam vaporization, resistance heating or inductive heating. Alternatively, the coating can be applied by a chemical coating process.

A preferred organic coating that can be used as the barrier layer 116 is a modified polyacrylic coating. Pre-coated films are commercially available from Kureha Chemical Industry Co. Ltd. of Tokyo, Japan and sold under the trademark BESELA. Such pre-coated films can be used as the core 112.

The laminate 110 includes a heat seal layer 122, 124 bonded to each of the first and second major surfaces 118, 120. A high temperature laminating adhesive 126 is used to laminate the heat seal layer 122 to the first major surface 118; and a high temperature laminating adhesive 128 is used to bond heat seal layer 124 to the second major surface 120. The high temperature laminating adhesive can be solvent-based or solventless, such as those described above in connection with the embodiment of FIG. 1.

The material of the heat seal layers 122, 124 is selected to form heat seals that can withstand retort sterilization, such as those conditions described above. Suitable materials for the heat seal layers 122, 124 include XLPE and CPP.

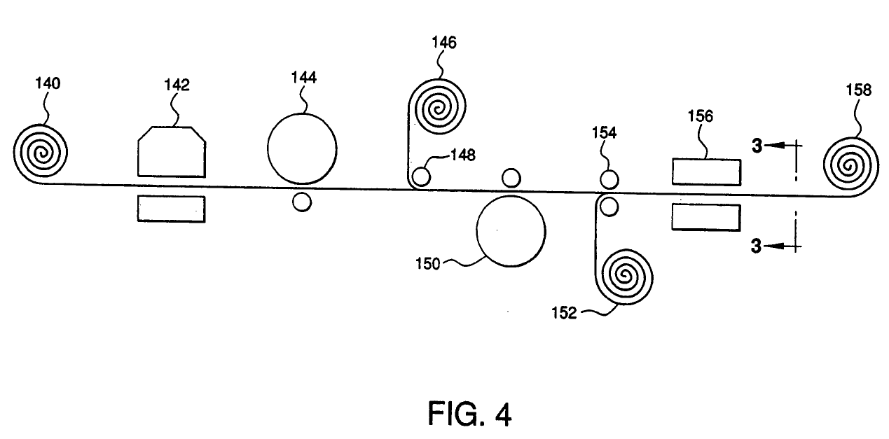

The laminate 110 can be made using the method and apparatus schematically shown in FIG. 4. A supply roll 140 of a suitable material for the strength layer 114 is provided on an unwind stand. A material web is unwound from the supply roll 140 and passed through a coating application station 142. The apparatus of the coating application is selected based upon the coating of the barrier layer 116. Apparatus for physical or chemical coating processes are known, as are suitable methods for applying organic coatings, such as a modified polyacrylic coating. If necessary, the coating application station can include a drying unit.

Once the barrier coating 116 has been applied at the coating application station 142, a suitable core 112 is formed, and the heat seal layers 122, 124 can be bonded to the first and second major surfaces 118, 120 thereof. The coated material web is passed through an adhesive coating station 144 where a high temperature laminating adhesive is coated onto the first major surface 118 of the core 112. A film of heat sealable material is unwound from roll 146 and brought into contact with the adhesive-coated first major side prior to passing through nip rolls 148.

The combined film is passed through a second adhesive coating station 150, where the second major surface 120 of the core 112 is coated with high temperature laminating adhesive. The film is then combined with a heat seal film from supply roll 152, which is brought into contact with the high temperature laminating adhesive on the second major surface 120. The combined film then passes through a second set of nip rolls 154. Although lamination of the heat seal layer 124 to the second major surface 120 is shown and described as the last step, it is also possible to bond heat seal layer 124 to major surface 120 prior to application of the barrier layer 116 and/or lamination of the heat seal layer 122.

After the heat seal layers 122, 124 have been combined with the core 112, the structure is passed through a curing station 156. The curing station may be a thermal drier if solvent- or water-based adhesive is used as the high temperature laminating adhesive. Once the adhesive layers are at least partially cured, the laminate 110 can be wound onto a take up roll 158.

A feature common to the various laminates of the present invention is the presence of a heat seal layer on each major surface of a core. Another important common feature is that each of the heat seal layers is bonded to the core by means of a high temperature laminating adhesive. The laminated structure is capable of withstanding retort conditions, followed by a period of storage and subsequent rethermalization.

Because the laminates of the present invention include heat seal layers on each major surface of the core, the laminates can be used to make pouches with lap seals or fin seals. A longitudinal lap seal is formed, for example, when the laminate is slit to an appropriate width, formed into a tubular structure with the opposed edges overlapped and heat sealed. Thus, the inside surface of one edge is sealed to the outside surface of the opposed edge with the seal extending substantially parallel with the adjacent portion of the tubular structure. A longitudinal fin seal, on the other hand, is formed when the inside surface of each opposed edge of the tubular structure are brought into contact with one another and sealed. Such a seal can extend in a direction independent of the adjacent portion of the tubular structure, and absent folding or other influence, sometimes tends to extend perpendicular thereto.

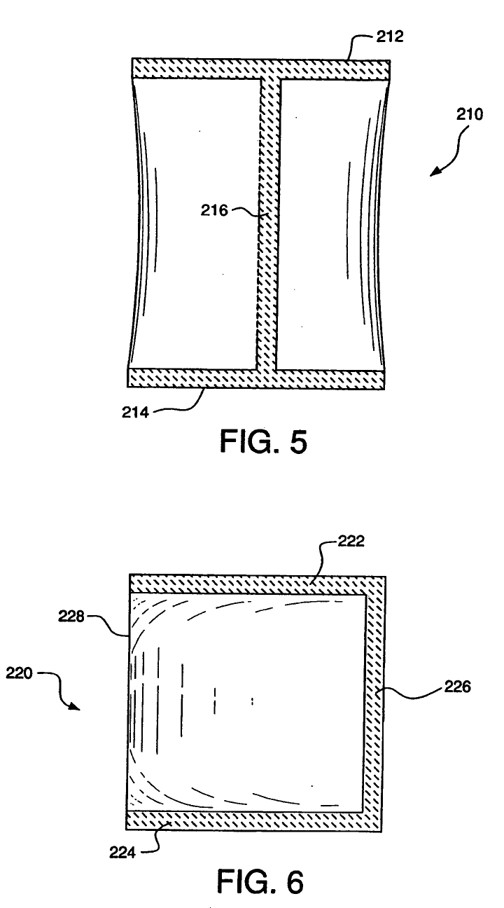

FIG. 5 shows a pillow pouch 210 formed from a laminate according to the present invention. The pouch 210 can be formed, filled and sealed on a vertical or horizontal form-fill-seal machine. The pouch includes a top heat seal 212 and a bottom heat seal 214, which are formed by collapsing the top and bottom of the tube between heat seal jaws and forming seals between the inner layers of the opposed sides. The pouch also includes a longitudinal lap seal 216, which is formed by folding the laminate into the tubular structure shown, contacting the outer surface of one edge of the tube with the inner layer of the overlapped opposed edge and sealing the outer surface to the overlapping inner surface.

When the pouch is formed on a vertical form-fill-seal (“VFFS”) machine, the laminate is first slit to the appropriate width. The laminate is then fed to the VFFS machine, which forms the tubular structure, the bottom seal 214 and longitudinal lap seal 216. The pouch is filled with a consumable product prior to forming the top seal 212.

The heat seal layers can be sealed between sealing jaws under pressure at relatively high temperatures in order to form the seals of the pouch 210. Appropriate sealing temperatures include 140-150 degrees C. if the heat seal layers are CPP, and 135-145 degrees C. for cross-linked polyethylene. Sealing can be performed under pressure of about 275 kilopascals (about 40 pounds per square inch) using a dwell time of about one second. Higher temperatures can be used if shorter dwell times are desired.

FIG. 6 shows another pouch 220 that can be made from the laminates of the present invention. The pouch 220 is a three-side seal pouch with a top seal 222, bottom seal 224 and a side seal 226. The pouch can be formed by folding a laminate of the present invention substantially in half to provide a folded side 228, then contacting and sealing the opposed inner surfaces of the bottom and right edges of the folded structure. The pouch 220 can be filled with consumables prior to sealing the top seal 222.

A variety of modifications to the embodiments described will be apparent to those skilled in the art from the disclosure provided herein. Thus, the present invention may be embodied in other specific forms without departing from the spirit or essential attributes thereof and, accordingly, reference should be made to the appended claims, rather than to the foregoing specification, as indicating the scope of the invention.

What is claimed is:

1. A pouch of the type that is formed, filled and sealed on a form, fill, seal machine, and in which consumables can be sterilized under retort conditions, the pouch comprising:
a laminate comprising
a core having first and second major surfaces, the core comprising
at least one plastic strength layer, and
a barrier comprising a material selected from the group consisting of ethylene vinyl alcohol copolymer, Nylon-MXD6, polyvinylidene chloride, an inorganic oxide coating and an organic coating,
a layer of high temperature laminating adhesive on each of the first and second major surfaces,
a heat seal layer laminated to each of the major surfaces by the high temperature laminating adhesive layers, the heat seal layers comprising a material having a melting point above 120 degrees C.;
the laminate being formed into a tubular structure, filled with consumable material and sealed.

2. The pouch of claim 1 wherein the barrier comprises an inorganic oxide coating on the strength layer.

3. The pouch of claim 1 wherein the barrier comprises an organic coating on the strength layer.

4. The pouch of claim 3 wherein the barrier comprises a modified polyacrylic coating on the strength layer.

5. The pouch of claim 1 wherein the core comprises a coextrusion of, in order, nylon, the barrier and nylon.

6. The pouch of claim 5 wherein the barrier is ethylene vinyl alcohol copolymer.

7. The pouch of claim 5 wherein the barrier is Nylon-MXD6.

8. The pouch of claim 5 wherein the coextrusion is mono-axially oriented.

9. The pouch of claim 8 wherein the tubular structure is formed in the direction of mono-axial orientation.

10. The pouch of claim 1 wherein the core comprises a coextrusion of, in order, polyester, the barrier and polyester.

11. The pouch of claim 10 wherein the barrier is ethylene vinyl alcohol copolymer.

12. The pouch of claim 10 wherein the barrier is Nylon-MXD6.

13. The pouch of claim 10 wherein the coextrusion is mono-axially oriented.

14. The pouch of claim 13 wherein the tubular structure is formed in the direction of mono-axial orientation.

15. The pouch of claim 1 wherein the heat seal layers comprise a material selected from the group consisting of polypropylene and cross-linked polyethylene.

16. The pouch of claim 15 wherein the heat seal layers comprise cast polypropylene.

17. The pouch of claim 1 wherein the tubular structure is formed with a longitudinal lap seal comprising a heat seal between the heat-seal layer laminated to the first major surface and the heat-seal layer laminated to the second major surface.

18. A lap sealable laminate for making a retort pouch, the laminate comprising:
a core having first and second major surfaces, the core comprising
at least one plastic strength layer selected from the group consisting of polyester, nylon, cast polypropylene and oriented polypropylene, and
a barrier comprising a material selected from the group consisting of ethylene vinyl alcohol copolymer, Nylon-MXD6, polyvinylidene chloride, an inorganic oxide coating and an organic coating;
a layer of high temperature laminating adhesive on each of the first and second major surfaces; and
a heat seal layer laminated to each of the major surfaces by the high temperature laminating adhesive layers, the heat seal layers comprising a material having a melting point above 120 degrees C.

19. The laminate of claim 18 wherein the barrier comprises an oxide coating on the strength layer.

20. The laminate of claim 18 wherein the barrier comprises an organic coating on the strength layer.

21. The laminate of claim 20 wherein the barrier comprises a modified polyacrylic coating on the strength layer.

22. The laminate of claim 18 wherein the core comprises a coextrusion of, in order, nylon, the barrier and nylon.

23. The laminate of claim 22 wherein the barrier is ethylene vinyl alcohol copolymer.

24. The laminate of claim 22 wherein the barrier is Nylon-MXD6.

25. The laminate of claim 22 wherein the coextrusion is mono-axially oriented.

26. The laminate of claim 25 wherein the tubular structure is formed in the direction of mono-axial orientation.

27. The laminate of claim 18 wherein the core comprises a coextrusion of, in order, polyester, the barrier and polyester.

28. The laminate of claim 27 wherein the barrier is ethylene vinyl alcohol copolymer.

29. The laminate of claim 27 wherein the barrier is Nylon-MXD6.

30. The laminate of claim 27 wherein the coextrusion is mono-axially oriented.

31. The laminate of claim 30 wherein the tubular structure is formed in the direction of mono-axial orientation.

32. The laminate of claim 18 wherein the heat seal layers comprise a material selected from the group consisting of polypropylene and cross-linked polyethylene.

33. The laminate of claim 32 wherein the heat seal layers comprise cast polypropylene.

34. The laminate of claim 18 wherein the heat seal layers comprise cross-linked polyethylene.

35. The laminate of claim 18 wherein the tubular structure is formed with a longitudinal lap seal comprising a heat seal between the heat-seal layer laminated to the first major surface and the heat-seal layer laminated to the second major surface.
